(19) United States
(12) Patent Application Publication
(10) Pub. No.: US 2013/0185325 A1
(43) Pub. Date: Jul. 18, 2013

(54) METHODS AND APPARATUS FOR PROVIDING CONTENT BASED ON SOCIAL NETWORKS

(71) Applicant: Thomas Schmidt, Stanford, CA (US)

(72) Inventor: Thomas Schmidt, Stanford, CA (US)

(73) Assignee: APPLE INC., Cupertino, CA (US)

(21) Appl. No.: 13/353,051

(22) Filed: Jan. 18, 2012

(51) Int. Cl. G06F 17/30

(52) U.S. Cl. 707/769; 707/E17.014

(57) ABSTRACT

Methods and apparatus for providing content based on social networks are provided. In particular, a user's social relationships or activities on a social network may be utilized to determine content such as products and/or items of interest to present to the user.

### BACKGROUND

Online shopping has become an increasingly popular way for consumers to purchase goods. In particular, there has been a rise in the sale of virtual products that are not physically tangible, but can still provide a consumer with enjoyment when used with, for example, an electronic device. Such virtual products can include, for example, virtual items for use in an online game and applications for use with an electronic device.

Due to the plethora of products available for purchase online, it may be difficult and/or time-consuming for a particular consumer to search and browse hundreds of products at a time. For example, current online shopping environments merely allow a shopper to browse and sort through available products by category, or search for products by entering a search query in a search field. However, even if a shopper comes across a potentially suitable product, there is often insufficient information for the shopper to make an informed purchase decision. An online shopping environment may provide reviews or comments about the product submitted by other consumers, but there is no way for a shopper to judge whether those other consumers have relevant tastes or preferences that are relevant to those of the shopper. Thus, there is a need to provide relevant shopping information to a shopper or consumer while shopping on-line.

### SUMMARY

Systems and methods are provided for utilizing information about a user's social network to provide content to the user.

In some embodiments, a method may be provided that may be implemented in a system that includes a user account database. The user account database may include a plurality of user accounts. Each user account may maintain a list of assets stored on one or more devices associated with that user account. Each user account may be associated with one or more social network user IDs. Each user may have associated relationship metrics that define a personal association probability value between that user account and each other user account based on access to at least one social network associated with the one or more social network user IDs of that user account. The method may include receiving an asset search query from a first user having a first user account in the user account database, and accessing an asset database to obtain a set of prioritized assets that correspond to the asset search query. The set of prioritized assets may be based on the relationship metrics associated with the first user account. The method may also include displaying at least a subset of the prioritized set of assets.

In some embodiments, a method may be provided that may include receiving a search query from a first user, determining a set of assets that corresponds to the received search query, determining a first social network user ID associated with the first user, and accessing a social network associated with the determined first social network user ID to identify at least one of a plurality of other social network user IDs that has a predefined relationship with the determined first social network user ID. The method may also include correlating one or more of the identified other social network user IDs to user accounts maintained in a user account database. Each user account may include a list of assets stored on one or more devices associated with that user account. The method may also include analyzing the list of assets associated with each correlated user account to prioritize the determined set of assets.

In some embodiments, a server may be provided and may include an input unit for receiving a search query, a data store for storing a user account database, and control circuitry. The control circuitry may be operative to, in response to the input unit receiving a search query from an electronic device of a first user, determine a set of assets that corresponds to the search query, and a first social network user ID associated with the first user. The control circuitry may also be operative to access a social network associated with the determined first social network user ID to identify at least one of a plurality of other social network user IDs that has a predefined relationship with the determined first social network user ID. The control circuitry may also be operative to correlate one or more of the identified other social network user IDs to user accounts maintained in the stored user account database. Each user account may include a list of assets stored on one or more devices associated with that user account. The control circuitry may also be operative to analyze the list of assets associated with each correlated user account to prioritize the determined set of assets.

In some embodiments, a method may be provided that may include receiving a search query from a first electronic device that is associated with a first user, generating a set of assets that corresponds to the received search query, accessing a social network to correlate the first user with a second user based on at least one characteristic of social network activity of the first user and at least one characteristic of social network activity of the second user, and in response to the correlating, prioritizing the generated set of assets.

In some embodiments, a method of presenting assets using an electronic device may be provided. The method may include receiving a search query from the input unit, and after the receiving the search query, displaying on the display a non-prioritized set of assets that corresponds to the received search query and a prioritize option for prioritizing the non-prioritized set of assets based on an association of the first user with a second user on a social network. The method may also include, after the displaying, receiving a user selection of the prioritize option, and in response to the receiving the user selection, displaying on the display a set of prioritized assets.

In some embodiments, an electronic device may be provided that may include a display, an input unit for receiving a user input, and control circuitry. The control circuitry may be operative to, in response to the input unit receiving a user input including a search query, direct the display to display a non-prioritized set of assets that corresponds to the received search query and a prioritize option for prioritizing the non-prioritized set of assets based on an association of the first user with a second user on a social network. The control circuitry may also be operative to, in response to the input unit receiving a user input including a selection of the prioritize option, direct the display to display a set of prioritized assets.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 shows a schematic view of an illustrative electronic device in accordance with some embodiments of the invention;

FIG. 2 shows a schematic view of an illustrative server in accordance with some embodiments of the invention;

FIG. 3 shows a communications topology including a server, a social network, and an electronic device in accordance with some embodiments of the invention;

FIGS. 4A and 4B show simplified representations of social networks including a plurality of users and their relationships in accordance with some embodiments of the invention;

FIG. 5 shows a data structure of assets stored on an electronic device and/or a server in accordance with some embodiments of the invention;

FIG. 6 shows a data structure of user account information stored on a server in accordance with some embodiments of the invention;

FIG. 7 shows a registration screen displayed on an electronic device in accordance with some embodiments of the invention;

FIG. 8 shows an asset search screen displayed on an electronic device in accordance with some embodiments of the invention;

FIGS. 9A to 9C show asset search results provided to and displayed using an electronic device in accordance with some embodiments of the invention;

FIG. 10 shows an illustrative process for providing asset search results based on social network information associated with a user in accordance with some embodiments of the invention;

FIG. 11 shows another illustrative process for providing asset search results based on social network information associated with a user in accordance with some embodiments of the invention;

FIG. 12 shows an illustrative process for providing asset search results based on social network characteristics of a user in accordance with some embodiments of the invention; and

FIG. 13 shows an illustrative process for presenting asset search results to a user on a display of an electronic device in accordance with some embodiments of the invention.

### DETAILED DESCRIPTION OF THE DISCLOSURE

In some embodiments, information about a user's acquaintances on one or more social networks can be aggregated and used to prioritize content or search results (e.g., during online shopping) presented to the user. Alternatively, or in addition, a user's behavior on one or more social networks can be compared with that of one or more other users on those social networks and information aggregated about these other users can be utilized to provide and/or prioritize content or search results that are presented to the user.

In particular, a user's social relationships or activities on a social network may be utilized to determine content, such as products and/or items of interest (hereafter “assets”), to present to the user. For example, on the Twitter™ social network, a user may “follow” or subscribe to posts or “tweets” (e.g., personal updates, blog entries, etc.) of one or more other users. The user can also be similarly “followed” by other users. These may be considered social relationships or activities and may be analyzed to provide more relevant content to the user. In some embodiments, the user may use an electronic device to search for an asset (e.g., a virtual product for use with an electronic device). In these embodiments, in addition to presenting matching assets found from a database, the system can determine whether users associated with the user (e.g., by analyzing the user's relationships on one or more social networks) have used and/or installed an asset included in the search results. In other embodiments, the system may determine a user to be a particular “type” (e.g., by analyzing characteristics of the user's “tweets”, blog entries, personal updates, etc. on one or more social networks). The determined “type” of the user can be used to find other users who may be of a similar “type” (e.g., other users who may have performed similar actions on the one or more social networks, and who may have purchased, used, and/or installed one or more assets included in the search results). Content can thus be provided to and/or prioritized for the user based on the user's relationships and/or activities on one or more social networks.

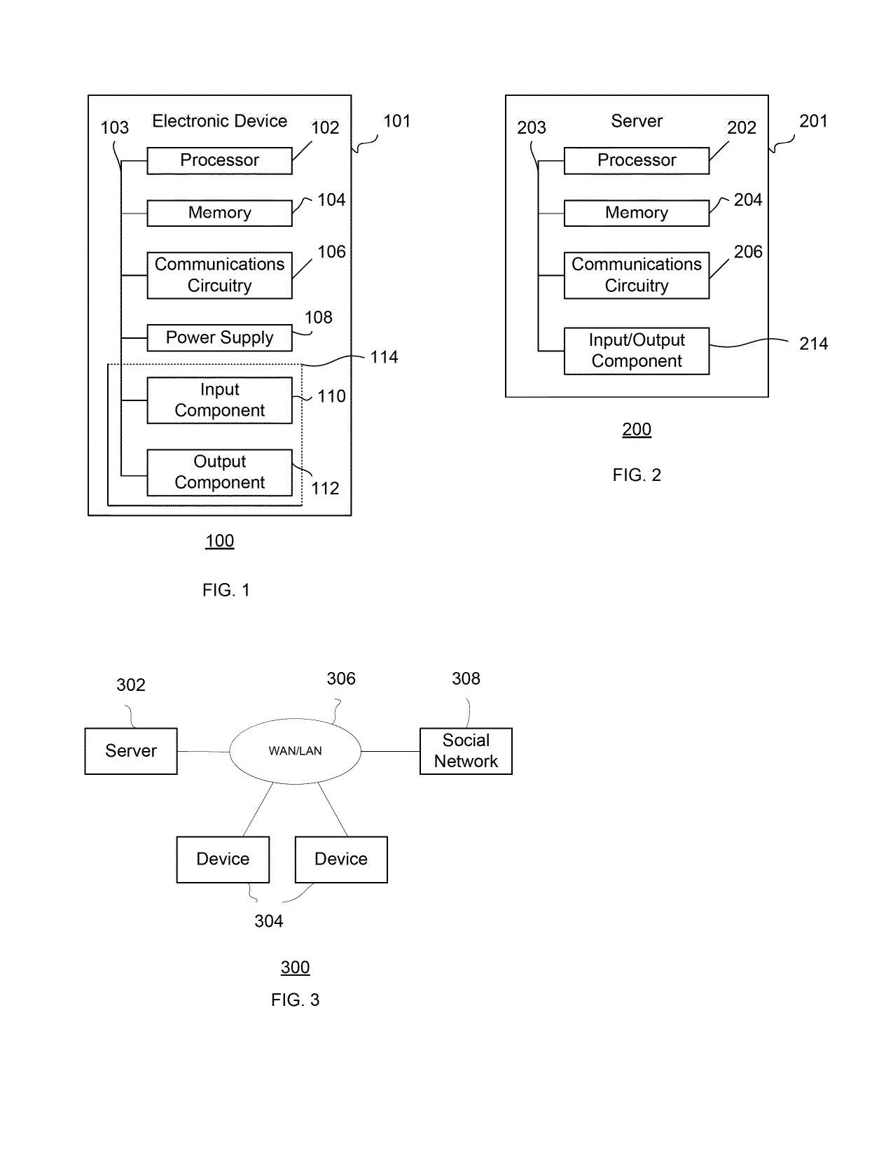

FIG. 1 is a schematic view of an illustrative electronic device 100 in accordance with some embodiments of the invention. Electronic device 100 may be any portable, mobile, or hand-held electronic device configured to receive a search query input by a user, transmit the search query to an external device, receive search results from the external device, and present the search results to the user. Alternatively, electronic device 100 may not be portable at all, but may instead be generally stationary. Electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet, server, etc.), monitor, television, stereo equipment, set up box, set-top box, boom box, modem, router, printer, and combinations thereof.

Electronic device 100 may include a processor or control circuitry 102, memory 104, communications circuitry 106, power supply 108, input component 110, and display 112. Electronic device 100 may also include a bus 114 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 1. For example, electronic device 100 may include motion-sensing circuitry, a compass, positioning circuitry, or several instances of the components shown in FIG. 1. For the sake of simplicity, only one of each of the components is shown in FIG. 1.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may store media data (e.g., music and image files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications circuitry 106 may be provided to allow device 100 to communicate with one or more other electronic devices or servers using any suitable communications protocol. For example, communications circuitry 106 may support Wi-Fi (e.g., an 802.11 protocol), Ethernet, Bluetooth™, high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), any other communications protocol, or any combination thereof. Communications circuitry 106 may also include circuitry that can enable device 100 to be electrically coupled to another device (e.g., a host computer or an accessory device) and communicate with that other device, either wirelessly or via a wired connection.

Power supply 108 may provide power to one or more of the components of device 100. In some embodiments, power supply 108 can be coupled to a power grid (e.g., when device 100 is not a portable device, such as a desktop computer). In some embodiments, power supply 108 can include one or more batteries for providing power (e.g., when device 100 is a portable device, such as a cellular telephone). As another example, power supply 108 can be configured to generate power from a natural source (e.g., solar power using solar cells).

One or more input components 110 may be provided to permit a user to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, proximity sensor, light detector, motion sensors, and combinations thereof. Each input component 110 can be configured to provide one or more dedicated control functions for making selections or issuing commands associated with operating device 100. Electronic device 100 may also include one or more output components that may present information (e.g., graphical, audible, and/or tactile information) to a user of device 100. An output component of electronic device 100 may take various forms, including, but not limited to, audio speakers, headphones, audio line-outs, visual displays, antennas, infrared ports, rumblers, vibrators, or combinations thereof.

For example, electronic device 100 may include display 112 as an output component. Display 112 may include any suitable type of display or interface for presenting visual data to a user. In some embodiments, display 112 may include a display embedded in device 100 or coupled to device 100 (e.g., a removable display). Display 112 may include, for example, a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or combination thereof. Alternatively, display 112 can include a movable display or a projecting system for providing a display of content on a surface remote from electronic device 100, such as, for example, a video projector, a head-up display, or a three-dimensional (e.g., holographic) display. As another example, display 112 may include a digital or mechanical viewfinder, such as a viewfinder of the type found in compact digital cameras, reflex cameras, or any other suitable still or video camera.

In some embodiments, display 112 may include display driver circuitry, circuitry for driving display drivers, or both. Display 112 can be operative to display content (e.g., media playback information, application screens for applications implemented on electronic device 100, information regarding ongoing communications operations, information regarding incoming communications requests, device operation screens, etc.) that may be under the direction of processor 102. Display 112 can be associated with any suitable characteristic dimensions defining the size and shape of the display. For example, the display can be rectangular or have any other polygonal shape, or alternatively can be defined by a curved or other non-polygonal shape (e.g., a circular display). Display 112 can have one or more primary orientations for which an interface can be displayed, or can instead or in addition be operative to display an interface along any orientation selected by a user.

It should be noted that one or more input components and one or more output components may sometimes be referred to collectively herein as an input/output (“I/O”) component or I/O interface (e.g., input component 110 and display 112 as I/O component or I/O interface 111). For example, input component 110 and display 112 may sometimes be a single I/O component 111, such as a touch screen, that may receive input information through a user's touch of a display screen and that may also provide visual information to a user via that same display screen.

Processor 102 of device 100 may include any processing circuitry operative to control the operations and performance of one or more components of electronic device 100. For example, processor 102 may be used to run operating system applications, firmware applications, media playback applications, media editing applications, or any other application. In some embodiments, processor 102 may receive input signals from input component 110 and/or drive output signals through display 112.

Processor 102 may load a user interface program (e.g., a program stored in memory 104 or another device or server) to determine how instructions or data received via an input component 110 may manipulate the way in which information is stored and/or provided to the user via an output component (e.g., display 112). Electronic device 100 (e.g., processor 102, memory 104, or any other components available to device 100) may be configured to process graphical data at various resolutions, frequencies, intensities, and various other characteristics as may be appropriate for the capabilities and resources of device 100.

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 110 may be an independent keyboard or mouse within its own housing that may wirelessly or through a wire communicate with processor 102, which may be provided within its own housing).

FIG. 2 shows a schematic view of an illustrative server in accordance with some embodiments of the invention. Server 200 may include a processor or control circuitry 202, memory 204, communications circuitry 206, input/output component 214, and a housing 201, which in some embodiments, may be the same as or similar to processor or control circuitry 102, memory 104, communications circuitry 106, input/output component 114, and a housing 101, respectively, of electronic device 100. For simplicity of description, details of each of these components of server 200 will not be repeated.

FIG. 3 shows a communications topology including a server, a social network, and an electronic device in accordance with some embodiments of the invention. Communications topology 300 shows a network including server 302, devices 304, WAN/LAN 306, and social network 308. In some embodiments, server 302 and devices 304 may be the same as or similar to server 200 and device 100, respectively. Each of server 302, devices 304, and social network 308 can communicate with each other over WAN/LAN 306. For example, server 302 can communicate with social network 308 or any of the devices 304 using communications circuitry that may be the same as or similar to communications circuitry 206. Likewise, any of devices 304 can communicate with social network 308 or server 302 using communications circuitry that may be the same as or similar to communications circuitry 106. In certain embodiments, each of server 302, devices 304, and social network 308 can also communicate with other devices (not shown) that may be connected to WAN/LAN 306. In other embodiments, social network 308 may be included as part of server 302.

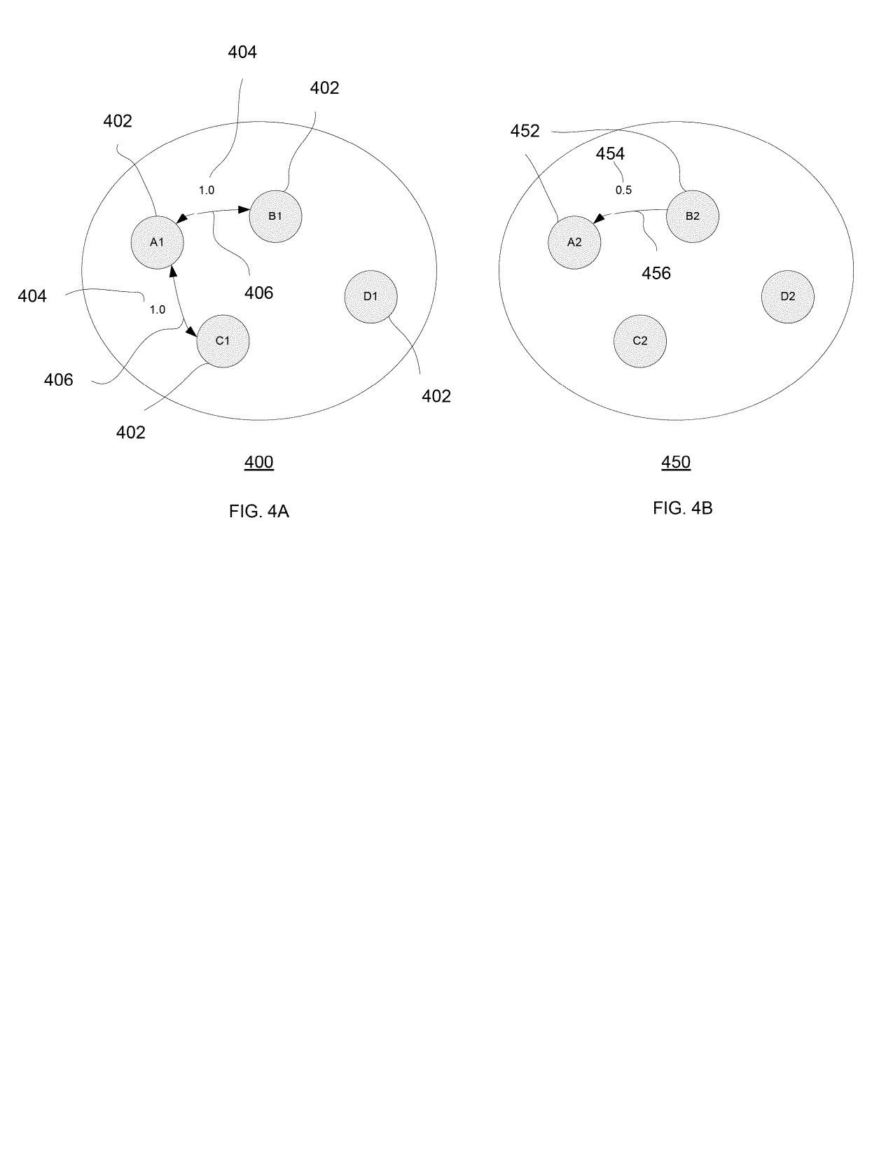

FIGS. 4A and 4B show simplified representations of different social networks including a plurality of users and their relationships in accordance with some embodiments of the invention. In certain embodiments, social networks 400 and 450 may be the same as or similar to social network 308. A social network may include any network that supports interactions between two or more users. Examples of social networks include Facebook™, Twitter™, MySpace™, etc. These are not the only social networks, but for the simplicity of description, networks such as these or similar to these are referred to throughout the description. Social networks, for example, can include one or more users, each user being associated with at least another user. The association may be initiated via an action, such as, for example, a user adding another user as a friend, or a user commenting on a personal entry or comment made by another user. Though not every social network may be structured the same way, most can be generally represented by the use of nodes (e.g., each node corresponding to a user) and links between the nodes (e.g., each link corresponding to a relationship between the connected nodes). It should be appreciated that social networks 400 and 450 are merely illustrate of some of many different social relationships that may exist in a social network.

Social network 400 may include a plurality of nodes 402 that may each correspond to a social network user ID. For example, a node 402 may correspond to a social network user ID ‘A1’ of a user A and another node may correspond to a social network ID ‘C1’ of a user C. User A and user C may interact on social network 400 and may, for example, become “friends”. This may result in a relationship link 406 being established between the node 402 corresponding to the social network user ID ‘A1’ and the node 402 corresponding to the social network user ID ‘B1’. It should be appreciated that relationship link 406 may only be one of many different types of relationship links that may exist in a social network. In addition, the personal association between user A and user C may result in a respective relationship value 404 being assigned to their relationship link 406. The relationship value may indicate the “strength” of the relationship between user A and user C, for example. Relationship value 404 corresponding to any relationship 406 may be determined and/or assigned by social network 400, and may be included in relationship data for social network 400. Such relationship data may be accessible by other devices such as, for example, server 302 and devices 304, over WAN/LAN 306.

Because different social networks may have different relationship structures, relationship data may not always be represented in the same way. For example, social network 400 may allow users A and C to become “friends” and the relationship between the two users may be treated as mutual (e.g., the relationship value of social network user ID ‘A1’ for user A with respect to social network user ID ‘B1’ for the user B may both be 1.0). In contrast, social network 450 of FIG. 4B may have a different relationship structure, and may include a plurality of nodes 452 that may each correspond to a social network user ID. For example, a node 452 may correspond to a social network user ID ‘A2’ of a user A and another node may correspond to a social network ID ‘B2’ of a user B. User A and user B may interact on social network 450 and may, for example, be established in a one-way relationship (e.g., user B initiates a relationship with user A, but user A does not do so in return). This may result in a relationship link 456 being established between the node 452 corresponding to the social network user ID ‘A2’ and the node 452 corresponding to the social network user ID ‘B2’, and a relationship value 454 may be assigned to this relationship link 456. The relationship value, in this scenario, may indicate a lower “strength” of relationship between user A and user B (as opposed to relationship value 404 for user A and user C of social network 400) because the relationship between user A and user B on social network 450 may only be one-way.

In some embodiments, relationship values 404 and 454 may or may not be provided in relationship data for each of social networks 400 and 450. In some embodiments, relationship values 404 and 454 may need to be determined from relationship data that is available from the social networks. For example, relationship data for social network 400 may only indicate that social network user ID ‘A1’ and social network user ID ‘B1’ are “related”. Based on the relationship structure of social network 400, it may be determined that a “related” relationship between two social network user IDs corresponds to a relationship value of 1.0 (e.g., a mutual relationship). In some embodiments, relationship data for social network 450 may only indicate that social network user ID ‘B2’ is “following” social network user ID ‘A2’. Based on the relationship structure of social network 450, it may be determined that the “following” is a one-way relationship between social network user ID ‘A2’ and social network user ID ‘B2’ and corresponds to a relationship value of 0.5 (e.g., a one-way relationship). In some embodiments, a one-way relationship may only be treated as relevant for, for example, social network user ID B2, but not social network user ID A2. Thus, a relationship value of 0.5 may be attributed to social network user ID ‘A2’ for social network user ID ‘B2’, but a different relationship value (e.g., 0) may be attributed to social network user ID ‘B2’ for social network user ID ‘A2’.

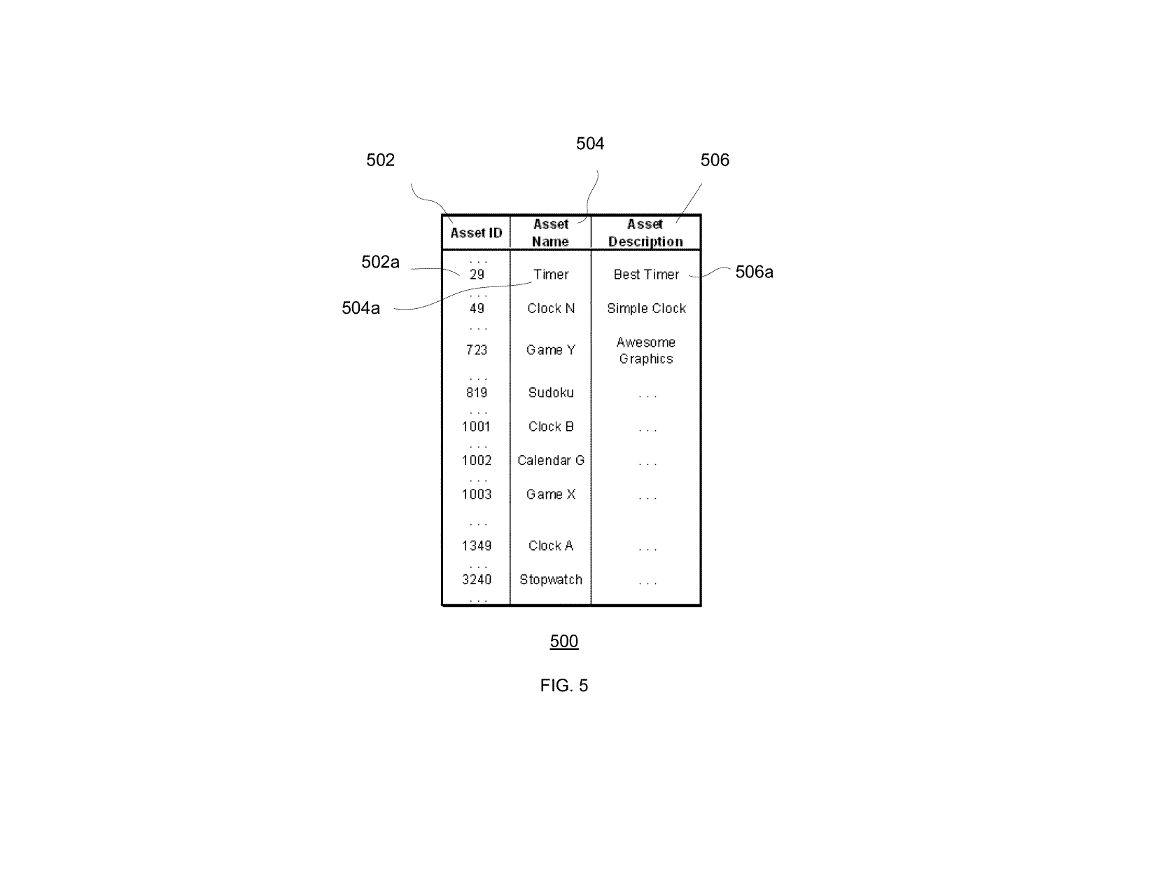

FIG. 5 shows a data structure of assets stored on an electronic device and/or a server in accordance with some embodiments of the invention. Data structure 500 may be stored in any suitable electronic device and/or server (e.g., device 100, devices 304, server 200, or server 302) and may include information for each asset, such as an asset ID 502, asset name 504, and asset description 506. An asset may be any type of content that a consumer may be interested in (e.g., a product, a third party application, a downloadable application that may be installed and/or operated on an electronic device, etc.). For example, data structure 500 may store ‘29’ in element 502a as a unique ID, which may be associated with an asset named ‘Timer’ stored in element 504a, and described as ‘Best Timer’ stored in element 506a.

In some embodiments, a server (e.g., server 200 or 302) may store data structure 500 to maintain an inventory of all the assets (e.g., which may or may not each be stored on the server itself) available for access. Data structure 500 may also be stored in an electronic device (e.g., device 100 or 304) to maintain a list of all the assets that are associated with the electronic device. The list of assets associated with the electronic device may be all of the assets that have been or once was installed on, used, or accessed by the electronic device. In some embodiments, the electronic device and the server may store the same or different information in data structure 500. For example server may store more detailed information regarding each asset in data structure 500 (e.g., purchase price, date of creation, etc.) that the electronic device may not need to store. In some embodiments, data structure 500 may be updated whenever an asset is added, deleted, or any information regarding the asset (e.g., asset name 504, asset description 506, etc.) is edited.

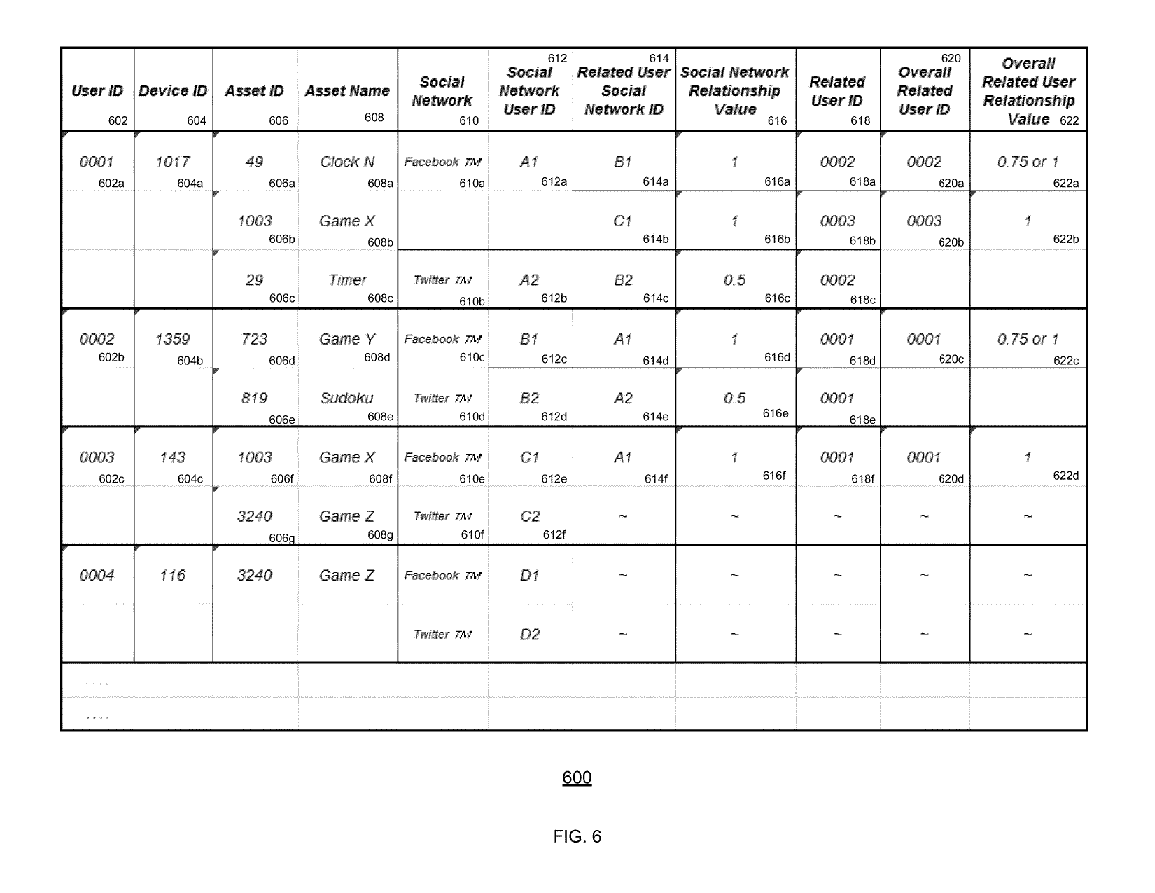

FIG. 6 shows a data structure of user account information stored on a server in accordance with some embodiments of the invention. Data structure 600 may be stored in any suitable device (e.g., server 200 or server 302). Data structure 600 may store a plurality of data associated with each user ID 602 that has been registered with the server. Such data can include a device ID 604, an asset ID 606, an asset name 608, a social network 610, a social network user ID 612, a related user social network ID 614, a social network relationship value 616, a related user ID 618, an overall related user ID 620, an overall related user relationship value 622, and any other suitable data.

For example, data structure 600 may store ‘0001’ in element 602a as a user ID for a first user A, which may be associated with a device (e.g., electronic device 100 or 304) with a device ID of ‘1017’ stored in element 604a. The device may be associated (e.g., installed, used, accessed, etc.) with assets such as ‘Clock N’ stored in element 608a corresponding to an asset ID of ‘49’ stored in element 606a, ‘Game X’ stored in element 608b corresponding to an asset ID of ‘1003’ stored in element 606b, and ‘Timer’ stored in element 608c corresponding to an asset ID of ‘29’ stored in element 606c. User ID 602a may be associated with one or more social networks (and corresponding social network IDs) and thus, data structure 600 may store ‘Facebook™’ in element 610a as one social network corresponding to a social network user ID of ‘A1’ stored in element 612a. Similarly, data structure may store ‘Twitter™’ in element 610b as another social network corresponding to a social network user ID of ‘A2’ stored in element 612b.

Likewise, data structure 600 may store ‘0002’ in element 602b as a user ID for a second user B, which may be associated with a device (e.g., electronic device 100 or 304) with a device ID of ‘1359’ stored in element 604b. The device may be associated with (e.g., installed, used, accessed, etc.) assets such as ‘Game Y’ stored in element 608d corresponding to an asset ID of ‘723’ stored in element 606d and ‘Sudoku’ stored in element 608e corresponding to an asset ID of ‘819’ stored in element 606e. User ID 602b may be associated with one or more social networks (and corresponding social network IDs) and thus, data structure 600 may store ‘Facebook™’ in element 610c as one social network corresponding to a social network user ID of ‘B1’ stored in element 612c. Similarly, data structure 600 may store ‘Twitter™’ in element 610d as another social network corresponding to a social network user ID of ‘B2’ stored in element 612d.

Further, data structure may store ‘0003’ in element 602c as a user ID for a third user C, which may be associated with a device (e.g., electronic device 100 or 304) with a device ID of ‘143’ stored in element 604c. The device may be associated with (e.g., installed, used, accessed, etc.) assets such as ‘Game X’ stored in element 608f corresponding to an asset ID of ‘1003’ stored in element 606f and ‘Game Z’ stored in element 608g corresponding to an asset ID of ‘3240’ stored in element 606g. User ID 602c may be associated with one or more social networks (and corresponding social network IDs) and thus, data structure 600 may store ‘Facebook™’ in element 610e as one social network corresponding to a social network user ID of ‘C1’ stored in element 612e. Similarly, data structure 600 may store ‘Twitter™’ in element 610f as another social network corresponding to a social network user ID of ‘C2’ stored in element 612f.

As mentioned above with respect to FIGS. 4A-4B, social network relationship data provided by or accessed from each social network (e.g., social network 400 and/or 450) may be used to determine social relationships between users on that social network. From this information, related user social network user IDs 614 may be determined and may be included in data structure 600 for each user ID 602. For example, it may be determined from social network relationship data of the social network ‘Facebook™’ that social network user ID ‘A1’ stored in element 612a is related to social network user ID ‘B1’ stored in element 612c and also related to social network ID ‘C1’ stored in element 612e. This information can be stored as respective related user social network user IDs ‘B1’ in element 614a and ‘C1’ in element 614b. As also mentioned with above with respect to FIGS. 4A-4B, relationship values between users on a social network may be determined using one or more suitable methods and may be included as part of the social network relationship data or may be determined (e.g., by the server) by analyzing any relationship data provided by the social network.

Regardless of how a relationship value between two users is provided or determined, data structure 600 may store such a relationship value as a social network relationship value 616. For example, data structure 600 may store (for social network user ID ‘A1’ stored in element 612a) a social network relationship value (e.g., ‘1’ in element 616a) that corresponds to related user social network user ID ‘B1’ stored in element 614a (which corresponds to social network user ID ‘B1’ stored in element 612c) and may also store a related user ID ‘0002’ in element 618a (which also corresponds to social network user ID ‘B1’ stored in element 612c). Because the first user A and the second user B may also be associated on the ‘Twitter™’ social network, data structure 600 may also store (for social network user ID ‘A2’ stored in element 612b) a social network relationship value (e.g., ‘0.5’ in element 616c) that corresponds to related user social network user ID ‘B2’ stored in element 614c (which corresponds to social network user ID ‘B2’ stored in element 612d) and may also store a related user ID ‘0002’ in element 618c (which also corresponds to social network user ID ‘B2’ stored in element 614c).

In some embodiments, when first user A and first user B are related on more than one social network, respective social network relationship values between the users may be different for each social network. Any suitable method for determining an overall related user relationship value may be employed. Some non-limiting examples can include taking one or more of an average, a maximum, a minimum, and a mean of the respective social network relationship values. In other embodiments, social network relationship values provided by or determined from social network relationship data of one or more social networks that may be less popular or less trustworthy, may be ignored or excluded. Thus, regardless of the method undertaken to evaluate the respective social network relationship values (if more than one exists), data structure 600 may also store, for example, overall related user ID ‘0002’ in element 620a and an overall related user relationship value (e.g., ‘0.75’ stored in element 622a). This overall related user relationship value may be used to determine the content to provide to a user. It should be appreciated that although numerical and/or fractional values ‘1’ and fractional value ‘0.75’ are shown, in some embodiments, other suitable representation of the social network relationship value (e.g., non-numerical) between two users may be used.

One or more of the related user social network user ID 614, social network relationship value 616, related user ID 618, overall related user ID 620, and overall related user relationship value 622 may also be similarly stored for user ID ‘0002’ of element 602b and user ‘0003’ of element 602c, etc. In some embodiments, for a user ID (e.g., ‘0001’ stored in element 602a), an overall related user relationship value (e.g., ‘0.75’ stored in element 622a) corresponding to an overall related user ID (e.g., ‘0002’ stored in element 620a) may be the same as that for another user ID (e.g., ‘0002’ stored in element 602b). That is, data structure 600 may also store an overall related user relationship value of ‘0.75’ in element 622c corresponding to over overall related user ID ‘0001’ stored in element 620c. This is because two users (e.g., user A and user B) may be related to each other in the same way, as determined from information from one or more social networks that the two users may be a part of. That is, the relationship between the two users may be reciprocal, and thus, each respective overall related user relationship value 622 may be the same. In other embodiments, the respective overall related user relationship value 622 for each of the two users (with respect to the other user) may be different based on any suitable predetermined criteria (e.g., set by the server). It should be appreciated that 0.75 and 1.0 are not the only possible relationship values. Any other values may occur, and may depend on the complexity of the social network relationship data that is provided by a particular social network. Further, users may be associated with each other on more than one social network. Relationship values stored in data structure 600 may depend on one or more of the respective relationship data of the different social networks.

In some embodiments, other data suitable to further define or identify any of the information in data structure 600 may also be included. For example, alternatively, or in addition to social network 610, a social network ID column may also be included to identify each social network 610 not by a text-based name, but by a unique value (e.g., a numerical value). In certain embodiments, less information may be stored in data structure 600. In other embodiments, more or less of the information shown in FIG. 6 may be arranged in any suitable manner.

In some embodiments, related user social network user IDs 614 and social network relationship values 616 may not be stored, where instead, data structure 600 may simply store overall related user IDs 620 and corresponding overall related user relationship values 622. Any intermediate analysis that may be required to determine the overall related user relationship values 622 between two users may still be required, but any intermediate information may not be stored in data structure 600.

Thus, as described above, data structure 600 may effectively provide an indication of the strength of relationships between users by referring to one or more social networks that the users may be a part of.

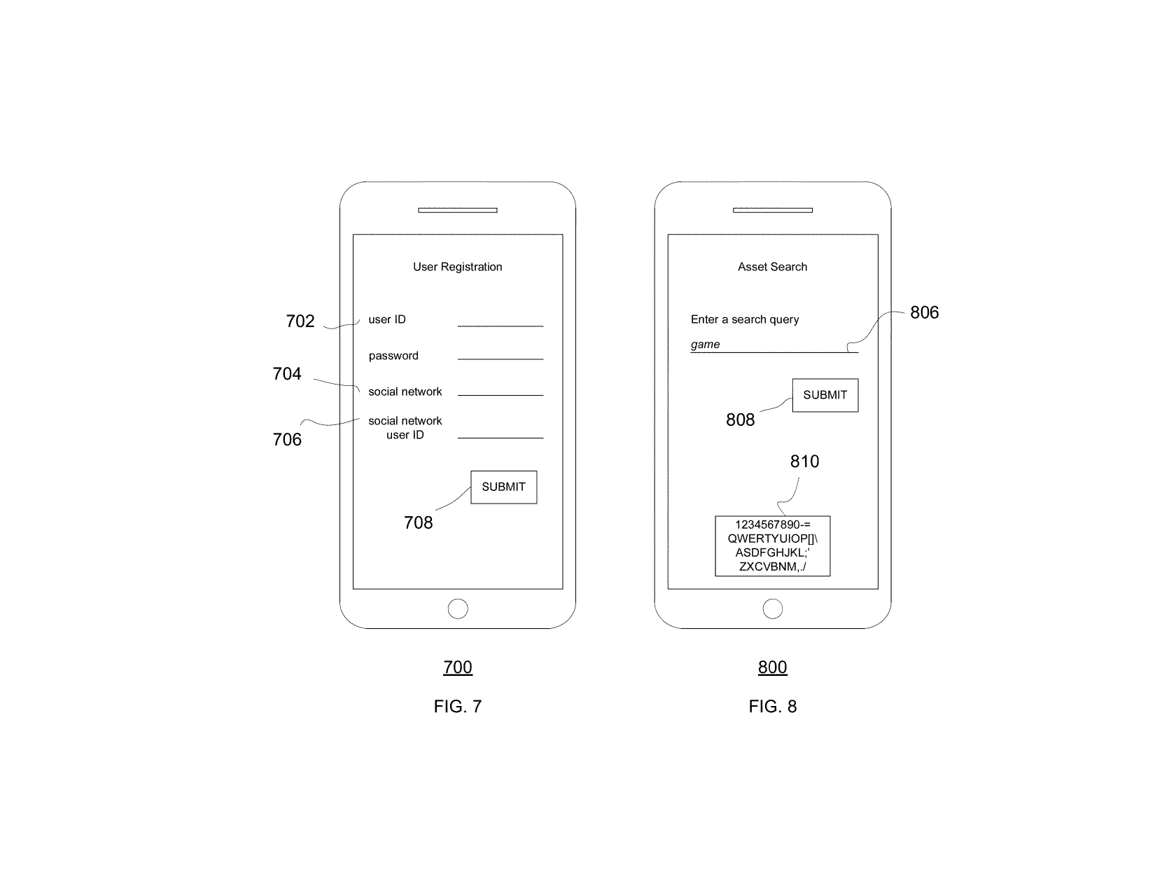

FIG. 7 shows a registration screen displayed on an electronic device in accordance with some embodiments of the invention. Registration screen 700 may be displayed on a display of a device (e.g., output component 112 of device 100) and may include prompts 702, 704, and 706. A user may register with a server (e.g., server 200 or 302) by entering the requested information for each of prompts 702, 704, and 706. For example, information entered for user ID 702, social network 704, and social network user ID 706 may be transmitted by the device (e.g., using communications circuitry 106) over a network (e.g., WAN/LAN 306) and received by the server (e.g., using communications circuitry 206). The server may store the received information as part of a data structure (e.g., data structure 600) in a memory, such as memory 204.

FIG. 8 shows an asset search screen displayed on an electronic device in accordance with some embodiments of the invention. Asset search screen 800 may be displayed on a display of a device (e.g., output component 112 of device 100) and may include prompt 806, a submit option 808, and an input interface 810 (e.g., input component 110). A user may search for assets by entering a search query for prompt 806. For example, a user may search for a game asset by typing the word ‘Game’. Upon selecting submit option 808, the search query may be processed (e.g., by processor 102 of device 100) and/or transmitted to a corresponding server (e.g., server 200 or 302).

The search query may be transmitted by the device (e.g., using communications circuitry 106) over a network (e.g., WAN/LAN 306) and received by the server (e.g., using communications circuitry 206). The server may process (e.g., parse the search query using processor 202 of server 200) the received search query and perform a search for an asset that may correspond to the search query by accessing a data structure (e.g., data structure 500).

Of course, any suitable method of entering a search query can be implemented. For example, the electronic device may include an application that can receive user voice commands, where instead of typing a search query on an asset search screen, a user can input a voice command to the application to perform an asset search. The application can process the received voice command and convert it into a machine recognizable search query. In some embodiments, the application can be an intelligent assistant application which can monitor a user's personality and/or preferences over a period of time. Upon receiving a user voice command to perform an asset search, the intelligent assistant can prioritize the asset search results for the user based on the monitored results. For example, if the user searched for a particular asset related to sports, and the intelligent assistant application determines that the user has previously been interested in a particular sport, any assets included in the asset search results that are related to the particular sport may be prioritized to a higher position when presented to the user.

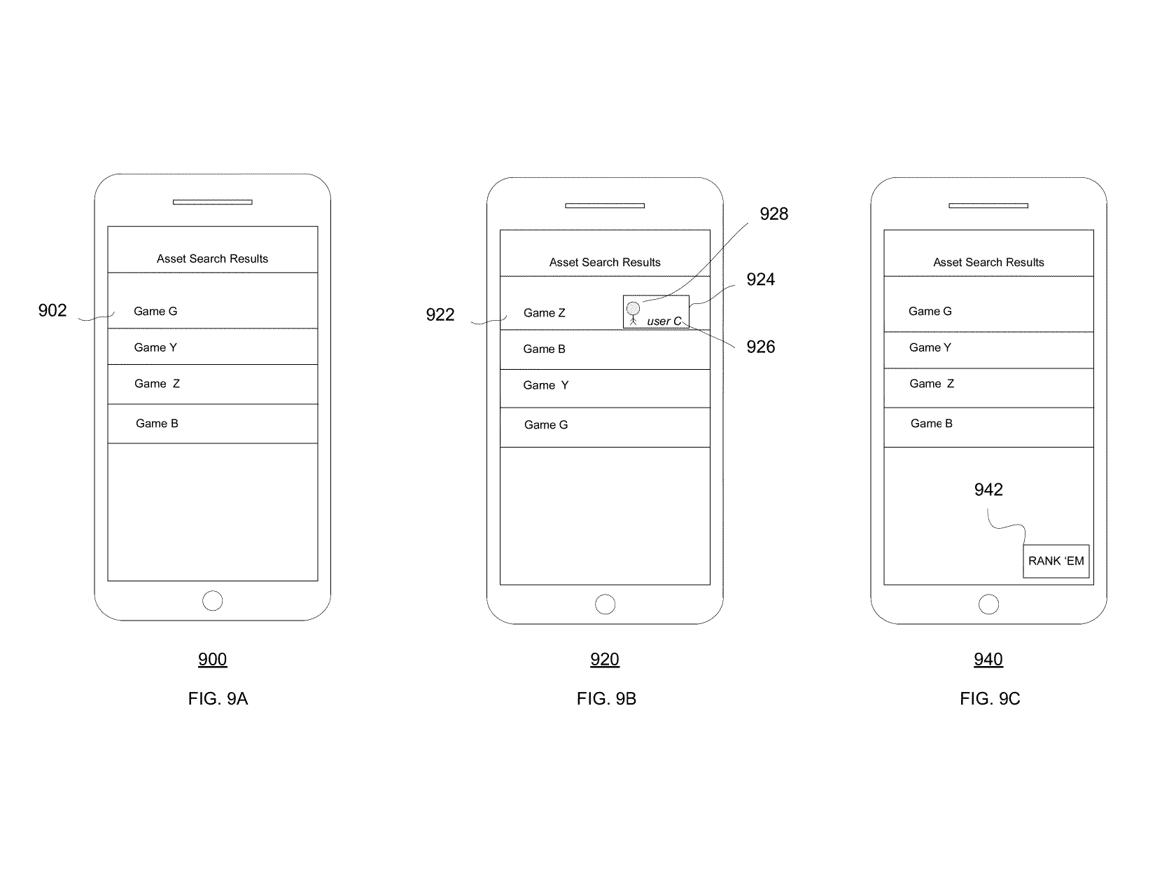

FIGS. 9A to 9C show asset search results provided to and displayed using an electronic device in accordance with some embodiments of the invention. Asset search results 900 of FIG. 9A may include a list of assets searched and found by a server (e.g., server 200 or 302) in response to a search query submitted by an electronic device (e.g., device 100 or 304). Asset search results 900 may be displayed on a display of a device (e.g., output component 112 of device 100) for a user of the device. For example, ‘Game G’ asset 902 may be included in the search results and may correspond to a search query that was submitted by the user of the device.

In some embodiments, asset search results 900 may simply include a list of found assets, where the list is in its original/unmodified form as provided by the server. In other embodiments, asset search results 900 may not be provided to the user, but may be rearranged or prioritized by the server based on social network related information associated with the user's account. For example, the server may determine that the user is associated with one or more other users (e.g., by referring to a data structure such as data structure 600). The user (e.g., ‘0001’ stored in element 602a) and one or more relationship values (e.g., ‘0.75’ stored in element 622a corresponding to user ID ‘0002’ stored in element 602b and/or ‘1’ stored in element 622b corresponding to user ID ‘0003’ stored in element 602c) may be identified in the data structure. The relationship values may be used along, or in conjunction, with other predetermined criteria, to determine whether asset search results 900 should be rearranged or prioritized. For example, user A (e.g., user ID ‘0001’ stored in element 602a) may be related to user C (e.g., user ID ‘0003’ stored in element 602c). The server may recognize that user C is associated with an asset ‘Game Z’ (e.g., element 608f) and that asset search results 900 also includes ‘Game Z’, and may prioritize ‘Game Z’ by placing it higher in the list of search results. For example, prioritized asset search results 920 of FIG. 9B shows ‘Game Z’ having been re-positioned higher in the list. Note that for prioritized asset search results 920, a related image 924 may also be displayed along with ‘Game Z’. User identifiers 926 and 928 may also be displayed that identify at least one user that the server may have identified as relevant (e.g., based on one or more overall related user relationship values 622) when rearranging or prioritizing the asset search results. For example, identifiers 926 and 928 may include a photo, image, name, username, and any other identifying information associated with the at least one relevant user.

As will be appreciated by those skilled in the art, the prioritization of asset search results (e.g., asset search results 900) described above may just be one of many suitable approaches. In some embodiments, the user may be related to one or more other users, where one or more of these other users may be associated with one or more assets included in asset search results. The process of prioritizing asset search results may include one of many different approaches. For example, some of these other users may be afforded a larger weight (e.g., according to any suitable criteria) than others in the rearranging or prioritizing. As another example, if more than one related user is identified to be associated with a particular asset in the asset search results, that particular asset may be arranged to a higher position in the list. As yet another example, if an equal number of related users is identified to be associated with two different assets, the two different assets may be arranged to higher positions in the list, but prioritized amongst each other by alphabetizing their asset names, by determining whether any of the related users for one of the two assets has a lower relationship value with the searching user, or by any other suitable prioritization scheme.

In some embodiments, the asset search results 940 may be displayed to the user, as shown in FIG. 9C. Asset search results 940 may be the same as or similar to asset search results 900. However, the user may be provided with rank option 942 for rearranging or prioritizing asset search results 940. For example, a separate list of prioritized asset search results (e.g., prioritized asset search results 920) may be provided to the electronic device by the server in addition to asset search results 940. When the user selects rank option 942, the device may update the display to display prioritized asset search results 920. In other embodiments, the server may not provide separate prioritized search results. Instead, the server may provide asset search results 940, but with supplemental information (not shown) that the device itself can use to rearrange or prioritize asset search results 940 to arrive at prioritized asset search results 920, for example.

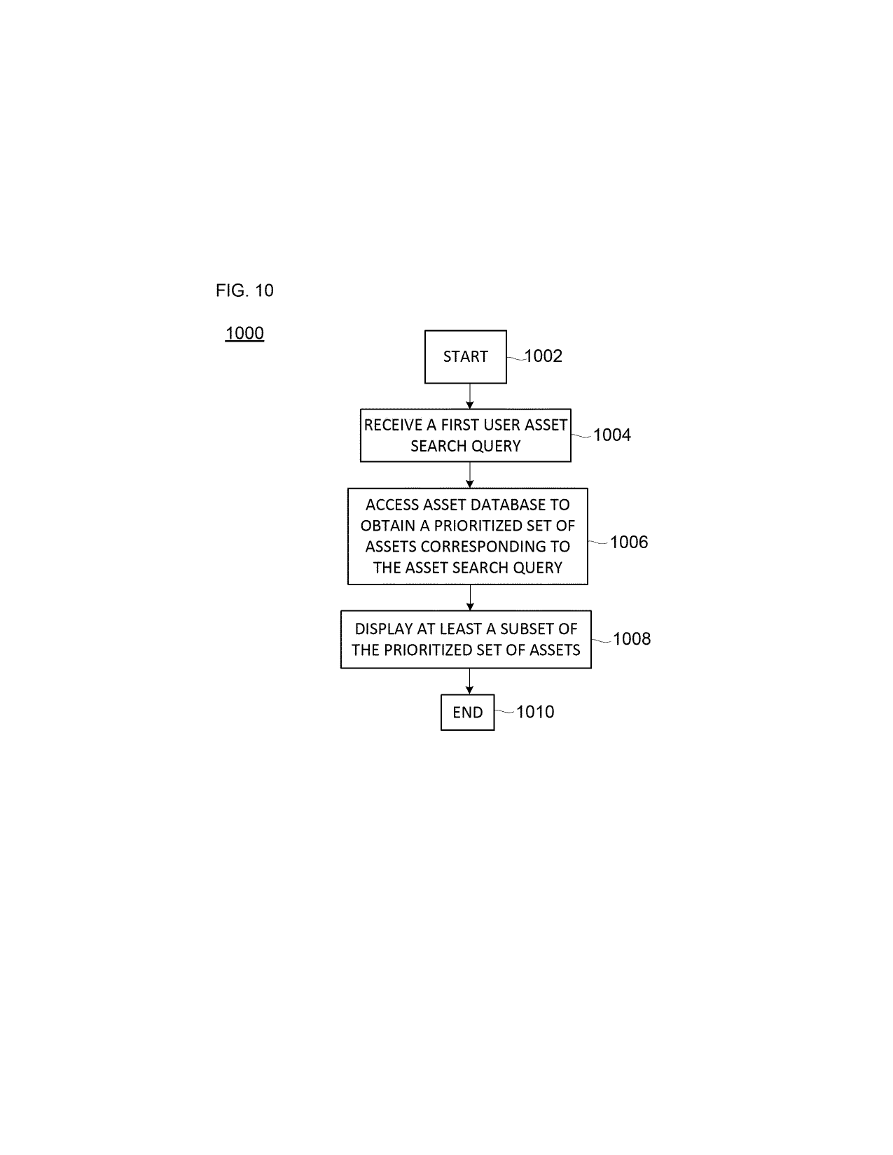

FIG. 10 shows an illustrative process for providing asset search results based on social network information associated with a user in accordance with some embodiments of the invention. Process 1000 may be performed by one or more suitable devices (e.g., device 100 or 304 and/or server 200 or 302). For example, a first user may be using an electronic device (e.g., device 100 or 304) to submit an asset search query to a server (e.g., server 200 or 302). The server may store an asset database (e.g., data structure 500) that may include some or all of the assets stored on the server or on any external device. The server may also store a user account database (e.g., data structure 600) that may include a plurality of user account information for each user that is registered with the server.

Process 1000 may begin at step 1002. At step 1004, the server may receive an asset search query from the first user having a first user account in the user account database. For example, a first user may be presented with an asset search screen (e.g., asset search screen 800) on a display (e.g., display 112) of an electronic device (e.g., device 100 or 304) and may enter one or more search terms as the asset search query. The server may receive the asset search query (e.g., using communications circuitry 206) from the electronic device and the process may proceed to step 1006.

At step 1006, the server may access the asset database (e.g., data structure 500) to obtain a set of prioritized assets that correspond to the received asset search query. For example, the first user may enter an asset search query ‘Game’ in the asset search screen. The server may access the asset database (e.g., data structure 500) to search for assets that corresponds to ‘Game’, and may produce asset search results (e.g., asset search results 900) based on what the server finds in the asset database. The server may then refer to the user account database (e.g., data structure 600) and may determine that the first user (e.g., user ID ‘0001’ stored in element 602a of data structure 600) is associated with another user account (e.g., user ID ‘0003’ stored in element 602b of data structure 600) and that a corresponding relationship metric or overall related user relationship value of this another user account, for the first user account, exceeds a threshold (e.g., ‘1’ stored in element 622b of data structure 600). In some embodiments, the threshold may be set according to any suitable criteria. In this example, the threshold may be 0.5. The server may also determine that the asset search results (e.g., asset search results 900) include a particular asset (e.g., ‘Game Z’) and that the another user account is associated with a device that is associated the same particular asset (e.g., ‘Game Z’ stored in element 608g of data structure 600). As a result, the server may prioritize the asset search results (e.g., asset search results 900) to produce at prioritized asset search results (e.g., prioritized asset search results 920). Thus, the set of prioritized assets may be based on the relationship metrics associated with the first user account. In some embodiments, the particular asset that is included in the asset search results and that is associated with the another user account may already be associated with the first user (e.g., in data structure 600). In this scenario, the server may remove the particular asset from the asset search results (e.g., asset search results 900) to avoid presenting assets that the first user is already associated with.

The set of prioritized assets can then be provided to the electronic device (e.g., using communications circuitry 106). Then, at step 1008, the server may display at least a subset of the prioritized set of assets. For example, the electronic device may display prioritized asset search results (e.g., prioritized asset search results 920) on a display (e.g., display 112). The process may then end at step 1010.

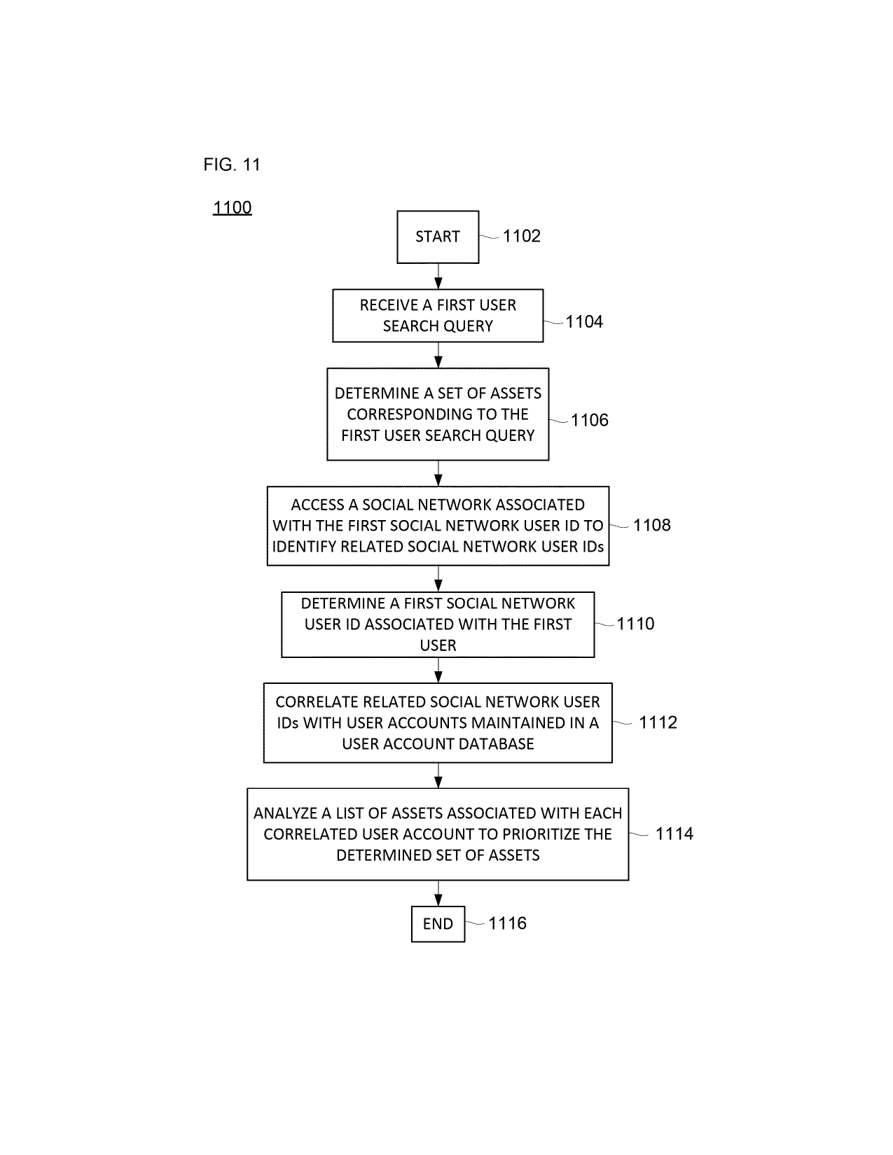

As described with respect to FIG. 10, process 1000 may involve accessing various user account information that is stored on the server as part of prioritizing asset search results. In some embodiments, the server may prioritize asset search results by referring a various user account information stored on the server, as well as by accessing one or more social networks associated with the user. FIG. 11 shows another illustrative process for providing asset search results based on social network information associated with a user in accordance with some embodiments of the invention. Process 1100 may be performed by any suitable device (e.g., server 200 or 302). For simplicity of description, however, process 1100 is described as being implemented by a server.

Process 1100 may begin at step 1102. At step 1104, the server may receive a search query from a first user. For example, a first user may be presented with an asset search screen (e.g., asset search screen 800) on a display (e.g., display 112) of an electronic device (e.g., device 100 or 304) and may enter one or more search terms as the asset search query. The server may receive the asset search query (e.g., using communications circuitry 206) from the electronic device and the process may proceed to step 1106. At step 1106, the server may determine a set of assets that corresponds to the received search query. For example, the server may access an asset database (e.g., data structure 500) to obtain a set of assets that corresponds to the received asset search query. For example, the first user may enter an asset search query ‘Game’ in the asset search screen. The server may access the asset database (e.g., data structure 500) to search for assets that correspond to ‘Game’, and may produce asset search results (e.g., asset search results 900) based on what the server finds in the asset database.

At step 1108, the server may determine a first social network user ID that is associated with the first user. For example, the server may refer to a user account database (e.g., data structure 600) and may determine that the first user (e.g., user ID ‘0001’ stored in element 602 of data structure 600) is associated with a first social network user ID (e.g., social network user ID ‘A1’ stored in element 612a of data structure 600).

At step 1110, the server may access a social network associated with the first social network ID to identify at least one of a plurality of other social network user IDs that has a predefined relationship with the first social network user ID. For example, the server may access a social network (e.g., ‘Facebook™’ stored in element 610a of data structure 600) corresponding to the first social network user ID using any suitable method (e.g., via an application programming interface (API) provided by the social network) and may determine that the first social network user ID has a predefined relationship with one or more other social network user IDs (e.g., social network user ID ‘C1’).

At step 1112, the server may correlate one or more of the identified other social network user IDs to user accounts maintained in a user account database. For example, the server may then determine that the one or more other social network user IDs are associated with other user accounts in the user account database (e.g., that social network user ID ‘C1’ stored in element 612e is associated with user account ID ‘0003’ stored in element 602c). The server may also determine that these other user accounts are associated with one or more assets (e.g., assets ‘Game X’ stored in element 608f and ‘Game Z’ stored in element 608g of data structure 600).

At step 1114, the server may analyze the list of assets associated with each correlated user account to prioritize the determined set of assets. For example, the server may determine that the asset search results (e.g., asset search results 900) include a particular asset (e.g., ‘Game Z’) and that one of the other user accounts is associated with the same particular asset (e.g., ‘Game Z’ stored in element 608g of data structure 600). As a result, the server may prioritize the asset search results (e.g., asset search results 900) to produce at prioritized asset search results (e.g., prioritized asset search results 920). The process may then end at step 1116. Thus, prioritizing of a set assets may be achieved by referring to both stored user account information and by accessing a social network associated with the first user.

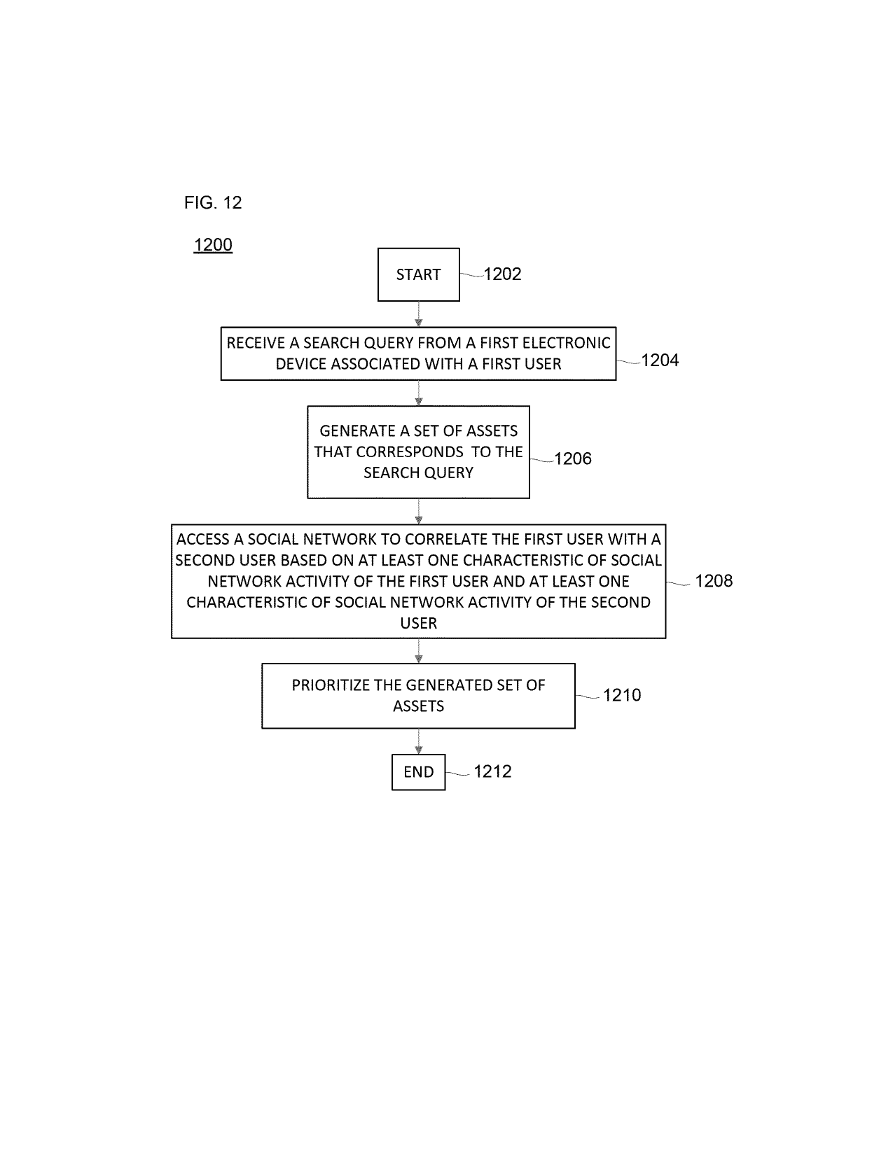

FIG. 12 shows a process for providing asset search results based on social network characteristics of a user in accordance with some embodiments of the invention. Social network activity characteristics may include anything that the user may say or do on a social network. For example, characteristics may include the user's posts, entries, and/or personal updates, friends, game play, etc. This information may be accessed from a social network's relationship data or any other data provided by the social network. Each user's social network activity characteristics may be different from another user's, but there may also be similarities. For example, a user A may play a particular game on a social network and a user B may also play the same game or a similar game. In some embodiments, social network activity characteristics may be stored in a data structure (e.g., data structure 600) for each user account. In other embodiments, this information can be produced and/or stored in and accessed from a remote device. Process 1200 may be performed by any suitable device (e.g., server 200 or 302). For simplicity of description, however, process 1200 is described as being implemented by a server.

Process 1200 may begin at step 1202. At step 1204, the server may receive a search query from a first electronic device that is associated with a first user. For example, a first user may be presented with an asset search screen (e.g., asset search screen 800) on a display (e.g., display 112) of an electronic device (e.g., device 100 or 304) and may enter one or more search terms as the asset search query. The server may receive the asset search query (e.g., using communications circuitry 206) from the electronic device and the process may proceed to step 1206.

At step 1206, the server may generate a set of assets that corresponds to the received search query. For example, the server may access an asset database (e.g., data structure 500) to obtain a set of assets that corresponds to the received asset search query. For example, the first user may enter an asset search query ‘Game’ in the asset search screen. The server may access the asset database (e.g., data structure 500) to search for assets that correspond to ‘Game’, and may produce asset search results (e.g., asset search results 900) based on what the server finds in the asset database.

At step 1208, the server may access a social network to correlating the first user with a second user based on at least one characteristic of social network activity of the first user and at least one characteristic of social network activity of the second user. For example, the server may refer to a user account database (e.g., data structure 600) and may determine that the first user (e.g., user ID ‘0001’ stored in element 602 of data structure 600) is associated with at least one characteristic of social network activity (not shown). In some embodiments, the server identify a first social network user ID (e.g., social network user ID ‘A1’ stored in element 612a of data structure 600) for the first user and may access the corresponding social network (e.g., social network ‘Facebook™’ stored in element 610a) to retrieve information about the characteristics of social network activity of the first user. The server may then determine whether other users (e.g., who may also be registered in the user account database and/or who may also part of the same social network as the first user, as determined by accessing the social network) have characteristics of social network activity that are the same as or are similar to that of the first user. It should be appreciated that any suitable technique for analyzing similarity of characteristics may be employed (e.g., determining if posts from each user relate to the same or similar topics, if their relationships with other users on the social network are the same or similar, etc.). If there is a similarity of characteristics of social network activity between the first user and a second user, the server may correlate the first user with the second user.

At step 1210, the server may, in response to the correlating, prioritize the generated set of assets. For example, the server may determine that the second user is associated with a second user account in the user account database (e.g., user account ID ‘0003’ stored in element 602c of data structure 600). The server may also determine that the second user account is associated with one or more assets (e.g., assets ‘Game X’ stored in element 608f and ‘Game Z’ stored in element 608g of data structure 600). The server may also determine that the asset search results (e.g., asset search results 900) include a particular asset (e.g., ‘Game Z’) and that the second user account is associated with the same particular asset (e.g., ‘Game Z’ stored in element 608g of data structure 600). As a result, the server may prioritize the asset search results (e.g., asset search results 900) to produce at prioritized asset search results (e.g., prioritized asset search results 920). The process may then end at step 1212. Thus, prioritizing of a set assets may be achieved by referring to characteristics of social network activity of the first user. In some embodiments, the prioritization schemes described above for any of processes 1000 and 1100 may be combined in any suitable manner with the prioritization scheme employed for process 1200.

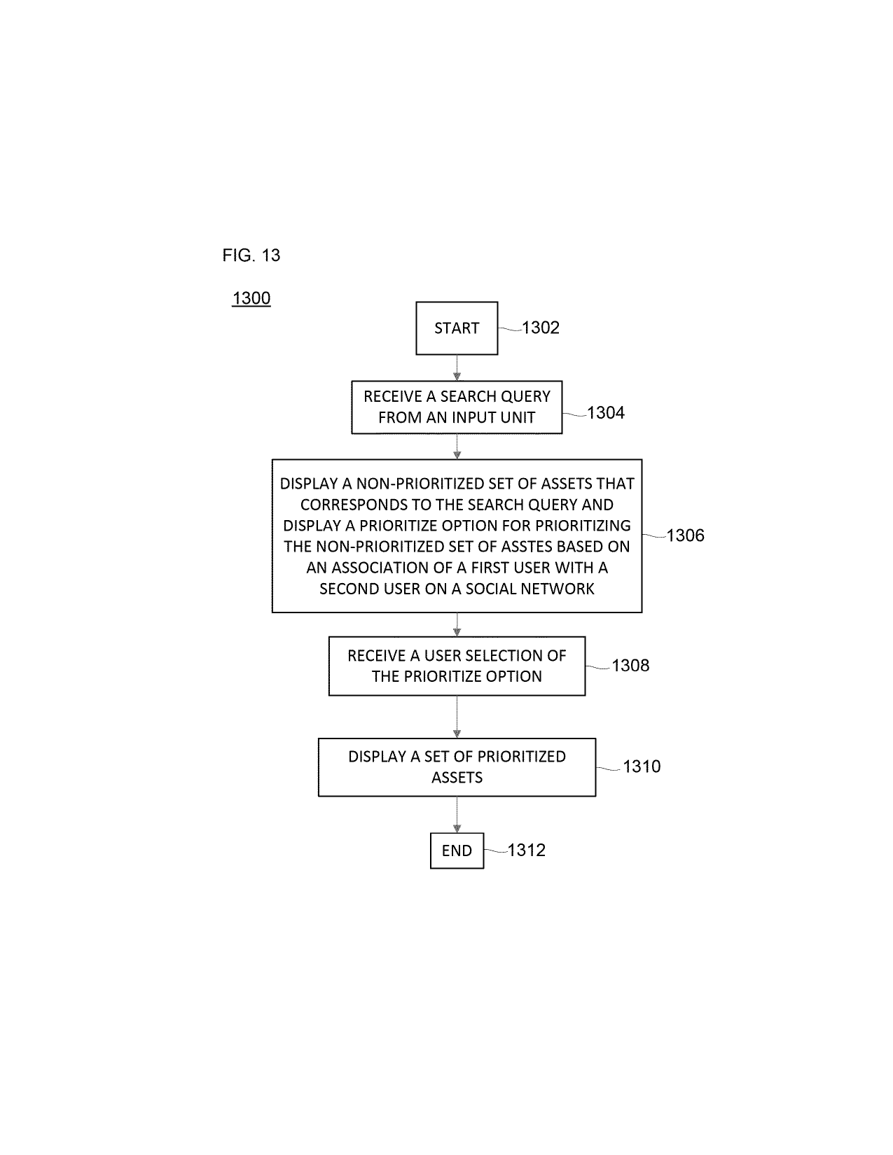

FIG. 13 shows a process for presenting asset search results to a user on a display of an electronic device in accordance with some embodiments of the invention. Process 1300 may be performed by any suitable device (e.g., device 100 or 304).

Process 1300 may begin at step 1302. At step 1304, the device may receive a search query from an input unit. For example, a first user may be presented with an asset search screen (e.g., asset search screen 800) on a display (e.g., display 112) of an electronic device (e.g., device 100 or 304) and may enter (e.g., using input component 110) one or more search terms as the asset search query. A server may receive the asset search query (e.g., using communications circuitry 206) from the electronic device, may generate asset search results (e.g., asset search results 900 of FIG. 9) and prioritized asset search results (e.g., asset search results 920 of FIG. 9), and may provide the generated results to the device.

Thus, at step 1306, the device may, after receiving the search query and after receiving various asset search results from the server, display on a display (e.g., display 112) a non-prioritized set of assets that corresponds to the received search query, and may display a prioritize option for prioritizing the non-prioritized set of assets based on an association of the first user with a second user on a social network. For example, the device may display a prioritize option (e.g., rank option 942) along with the asset search results (e.g., asset search results 940).

At step 1308, the device may, after the displaying, receive a user selection of the prioritize option. At step 1310, the server may, in response to receiving the user selection, display on the display a set of prioritized assets. For example, in response to receiving a user selection of rank option 942, the device may display prioritized asset search results 920. The process may then end at step 1312.

It should be understood that the steps shown in FIGS. 10-13 are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A method implemented in a system comprising a user account database comprising a plurality of user accounts, each user account maintaining a list of assets stored on one or more devices associated with that user account, and each user account is associated with one or more social network user IDs, wherein each user account has associated relationship metrics that define a personal association probability value between that user account and each other user account based on access to at least one social network associated with the one or more social network user IDs of that user account, the method comprising:
receiving a first user asset search query, the first user having a first user account in the user account database;
accessing an asset database to obtain a set of prioritized assets that correspond to the asset search query, wherein the set of prioritized assets is based on the relationship metrics associated with the first user account; and
displaying at least a subset of the prioritized set of assets.

2. The method of claim 1, wherein the set of prioritized assets includes assets identified in the list of assets of other user accounts in the user account database that exceed a personal association probability value threshold.

3. The method of claim 2, wherein the set of prioritized assets excludes identified assets already included in the list of assets associated with the first user account.

4. The method of claim 1, wherein the at least one social network comprises a plurality of users, wherein at least a first user of the plurality of users is associated with at least a second user of the plurality of users based on predetermined criteria.

5. The method of claim 4, wherein the predetermined criteria is at least based on actions performed by the first user to become associated with at least a second user.

6. The method of claim 1, wherein the assets are downloadable applications that can be installed and operated on an electronic device.

7. The method of claim 1, further comprising:
displaying a user selectable option that determines whether the subset of prioritized assets or a subset of non-prioritized assets corresponding to the asset search query are to be displayed,
wherein when the user selectable option is selected, displaying at least a subset of the prioritized set of assets; and
wherein when the user selectable option is not selected, displaying at least a subset of the non-prioritized assets.

8. A method comprising:
receiving a first user search query;
determining a set of assets that corresponds to the first user search query;
determining a first social network user ID associated with the first user;
accessing a social network associated with the determined first social network user ID to identify at least one of a plurality of other social network user IDs that has a predefined relationship with the determined first social network user ID;
correlating one or more of the identified other social network user IDs to user accounts maintained in a user account database, each user account including a list of assets stored on one or more devices associated with that user account; and
analyzing the list of assets associated with each correlated user account to prioritize the determined set of assets.

9. The method of claim 8, wherein the accessing comprises retrieving social network data.

10. The method of claim 9, wherein the retrieved social network data defines relationships between a plurality of users of the social network.

11. The method of claim 8, wherein analyzing comprises determining that a first asset included in the determined set of assets is also included in at least one of the list of assets.

12. The method of claim 11, wherein the analyzing further comprises adjusting a position of the first asset in the determined set of assets.

13. The method of claim 12, wherein the adjusted position of the first asset is higher than an initial position in the determined set of assets of the first asset.

14. A server comprising:
an input unit for receiving a search query;
a data store for storing a user account database; and
control circuitry operative to:
in response to the input unit receiving a search query from a first user's electronic device, determine:
a set of assets that corresponds to the search query; and
a first social network user ID associated with the first user;
access a social network associated with the determined first social network user ID to identify at least one of a plurality of other social network user IDs that has a predefined relationship with the determined first social network user ID;
correlate one or more of the identified other social network user IDs to user accounts maintained in the stored user account database, each user account including a list of assets stored on one or more devices associated with that user account; and
analyze the list of assets associated with each correlated user account to prioritize the determined set of assets.

15. A method comprising:
receiving a search query from a first electronic device that is associated with a first user;
generating a set of assets that corresponds to the received search query;
accessing a social network to correlate the first user with a second user based on at least one characteristic of social network activity of the first user and at least one characteristic of social network activity of the second user; and
in response to the correlating, prioritizing the generated set of assets.

16. The method of claim 15, wherein the detecting comprises:
retrieving social network data from a social network; and
analyzing at least a first portion of the retrieved social network data that corresponds to the first user and at least a second portion of the retrieved social network data that corresponds to the second user.

17. The method of claim 15, wherein the prioritizing the generated set of assets comprises:
determining that the detected at least one characteristic of social network activity of the first user is similar to the detected at least one characteristic of social network activity of the second user; and
determining that at least one asset of the generated set of assets is associated with the second user.

18. The method of claim 15 further comprising providing the prioritized set of assets to the first electronic device.

19. A method of presenting assets using an electronic device that is associated with a user, the electronic device comprising an input unit and a display, the method comprising:
receiving a search query from the input unit;
after the receiving the search query, displaying on the display:
a non-prioritized set of assets that corresponds to the received search query; and
a prioritize option for prioritizing the non-prioritized set of assets based on an association of the first user with a second user on a social network;
after the displaying, receiving a user selection of the prioritize option; and
in response to the receiving the user selection, displaying on the display a set of prioritized assets.

20. The method of claim 19, wherein the second user is associated with an asset included in the non-prioritized set of assets.

21. The method of claim 19, wherein the displaying the prioritized set of assets comprises displaying information regarding the second user.

22. The method of claim 21, wherein information regarding the second user comprises identifying information that identifies the second user.

23. The method of claim 22, wherein the set of prioritized assets comprises at least a portion of the assets included in the non-prioritized set of assets.

24. The method of claim 23, wherein the at least a portion of the set of prioritized assets is less than all of the assets included in the non-prioritized set of assets.

25. An electronic device comprising:
a display;
an input unit for receiving a user input; and
control circuitry operative to:
in response to the input unit receiving a user input comprising a search query, direct the display to display:
a non-prioritized set of assets that corresponds to the received search query; and
a prioritize option for prioritizing the non-prioritized set of assets based on an association of the first user with a second user on a social network; and
in response to the input unit receiving a user input comprising a selection of the prioritize option, direct the display to display a set of prioritized assets.
